(19) United States
(12) Patent Application Publication
(10) Pub. No.: US 2005/0083370 A1
(43) Pub. Date: Apr. 21, 2005

(54) METHOD AND DEVICE FOR BOOSTING PRINTING SPEED OF A PRINTER

(76) Inventor: Chien-Hsien Ho, I-Lan City (TW)

Correspondence Address: NORTH AMERICA INTERNATIONAL PATENT OFFICE (NAIPC), P.O. BOX 506, MERRIFIELD, VA, 22116, US

(21) Appl. No.: 10/711,934

(22) Filed: Oct. 13, 2004

(30) Foreign Application Priority Data
Oct. 17, 2003 (TW) 092128937

(51) Int. Cl. B41J 29/38

(52) U.S. Cl. 347/37

(57) ABSTRACT

A method and device for boosting printing speed of a printer. The method includes moving a printhead toward a first swath area of a medium according to a first direction, controlling the printhead according to a print data for printing the print data on the first swath area, and moving the printhead toward a second swath area next to the first swath area according to a second direction opposite to the first direction when the printhead has left the first swath area and the medium is still moving along a predetermined direction to make the second swath area capable of being printed by the printhead.

### BACKGROUND OF INVENTION

1. Field of the Invention

The present invention relates to a method and device for driving a printing device. More specifically, the present invention discloses a method and device for boosting the printing speed of a printer.

2. Description of the Prior Art

A printing device means a device with a printhead attached to a carrier and a motor implemented for moving the carrier back and forth in order to print data on a medium. Generally speaking, the printhead prints the data on a medium using a method such as ink jetting, dot pattern, or thermal transfer. However, the carrier moves only in a horizontal direction, meaning that the printhead on the carrier can only print in a limited area. Therefore the printing device needs another motor to drive the medium vertically so that the printhead can finish printing data on the medium successfully. Please refer to FIG. 1 to 3. FIGS. 1-3 are diagrams illustrating operations of a prior art printing device 10. The printing device 10 comprises a shaft 111 that has a printhead 12 attached to it, wherein the printhead 12 moves back and forth on the shaft 111 so as to print data on the medium 14. In FIG. 1, the medium 14 and the printhead 12 are reposed at the beginning and ready to operate printing on the swath area 16 of the medium 14 when informed by the print data. Then the printhead 12 accelerates toward the swath area 16 according to direction A. However, when the printhead 12 enters the swath area 16, the printhead 12 moves across the swath area 16 with steady speed while printing so as to not ruin the printing quality because of the acceleration of printhead 12.

As shown in FIG. 2, the printhead 12 has finished the printing operation corresponding to the printing area 16. When the print head 12 leaves the swath area 16, the printhead 12 decelerates until it stops. Additionally, the medium 14 begins to move along the direction B (which is vertical to the direction A) in order to process the next swath area 18 after the printhead 12 has left the swath area 16. If the printhead 12 is reposed and the medium 14 is still moving along the direction B, the printhead 12 will remain reposed because the next swath area 18 has not reached the processing area for printhead 12.

As shown in FIG. 3, the swath area 18 is totally in the processing area of the printhead 12, and the reposed printhead 12 begins to accelerate toward the swath area 18 along the direction A′ which is opposite of the direction A since the medium 14 is still instead of moving. When the printhead 12 enters the swath area 18, the printhead 12 moves back and prints with a steady speed. When the printhead 12 leaves the swath area 18, the printhead 12 has finished the printing operation in swath area 18 so as a result, the printhead 12 decelerates until it stops. Note, the lengths of swath areas 16 and 18 depend on the print data. That is to say, the printhead 12 will determine the beginning and end position of the printing operation on the medium 14.

As mentioned above, the prior art printing device will drive the medium 14 to move along the direction B when the printhead 12 finishes the printing operation in the swath area 16. That is to say, the medium 14 begins to move when the printhead 12 is decelerating and has not yet come to a stop. However, if the printhead 12 is reposed but the medium 14 has not finished the paper feeding operation for the next swath area 18, the prior art printing device will not move toward the swath area 18 in order to continue printing operation. The prior art printing device will only move forward after the paper feeding operation for the swath area 18 has finished. As a result, extra time is spent by the printhead 12 while waiting for the paper feeding operation to finish, which results in an increase in printing time, which makes the prior art printing device less efficient.

### SUMMARY OF INVENTION

It is one of the objectives of the present invention to provide a method and device capable of boosting the printing speed of a printer to solve the above-mentioned problem.

According to the embodiment of the present invention, a method for driving a printing device to print a first print data and a second print data on a medium is disclosed. The printing device has a printhead, and the medium has a first swath area and a second swath area. The method comprises (a) moving the printhead along a first direction toward the first swath area, and controlling the printhead to print the first print data on the first swath area; and (b) when the printhead has printed the first print data on the first swath area, moving the printhead to approach the second swath area along a second direction opposite of the first direction while the medium moves along a predetermined direction.

According to the embodiment of the present invention, a method for driving a printing device is disclosed. The printing device has a printhead. The method comprises (a) controlling the printhead to move along a first direction toward a first swath area of a medium, and controlling the printhead to print a print data on the first swath area according to the print data; (b) when the printhead has left the first swath area according to the first direction, driving the medium to move along a predetermined direction, computing a first duration by counting the time it takes the medium to move according to the predetermined direction so that the printhead can print on a second swath area next to the first print swath area, and computing a second duration by counting the time it takes the printhead to move from the first print swath area to the second swath area along the second direction opposite of the first direction; and (c) comparing the first duration with the second duration for controlling the timing when the printhead starts moving toward the second swath area according to the second direction.

According to the embodiment of the present invention, a printing device is disclosed. The printing device comprises a printhead for respectively printing a first print data and a second print data on a first swath area and a second swath area; and a controller electrically connected to the printhead for controlling the printhead to move along a first direction to print the first print data on the first swath area, and controlling the medium to move along a predetermined direction and the printhead to approach the second swath area along a second direction opposite of the first direction when the printhead has printed the first print data on the first swath area.

According to the embodiment of the present invention, a printing device is disclosed. The printing device comprises a printhead for printing a print data on a first swath area of a medium along a first direction according to the print data; and a controller electrically connected to the printhead, wherein when the printhead has left the first swath area according to the first direction, the controller controls the medium to move along a predetermined direction, computes a first duration by counting the time it takes the medium to move according to the predetermined direction so that the printhead can print on a second swath area next to the first print swath area, computes a second duration by counting the time it takes the printhead to move from the first print swath area to the second swath area along the second direction opposite of the first direction, and compares the first duration with the second duration for controlling the timing when the printhead starts moving toward the second swath area according to the second direction.

The present invention promotes the printing speed by driving the reposed printhead to move toward the swath area in a corresponding paper feeding operation corresponding to the swath area. The above-mentioned paper feeding operation is finished in the duration of the deceleration of the printing operation of the current printing area and the time the next printing operation of the next swath area begins. Thus, the operation time for the printhead to move from the swath area that has been printed to the next swath area may be greatly decreased so as to boost the print speed.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIGS. 1-3 are the diagrams illustrating operations of a prior art printing device.

FIG. 4 is a block diagram of a printing device according to the present invention.

FIG. 5 is a first operation flowchart of the printing device shown in FIG. 4

FIG. 6 is a second operation flowchart of the printing device shown in FIG. 4

### DETAILED DESCRIPTION

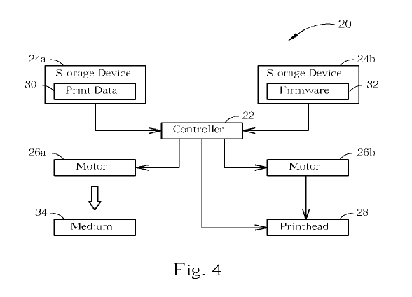

Please refer to FIG. 4. FIG. 4 is the block diagram of the printing device 20 of the present invention. The printing device 20 comprises a controller 22, two storage device 24a and 24b, two motors 26a and 26b, and a printhead 28. The controller 22 is used for controlling the operation of the printing device 20 (such an ink-jet printer). The storage 24a is used for storing the print data 30, so the controller 22 can read the print data 30 from the storage device 24a so as to print the print data 30 on the medium 34. And the storage 24b is used for storing the firmware 32 so that the controller 22 can read the firmware 32 from the storage 24b and operate the corresponding program code of the firmware 32 so as to control the printing operation. When the medium 34 (such as a piece of paper) is loaded on the printing device 20, the motor 26a is used for controlling the vertical movement of the medium 34, which means the motor 26a is used to operate the paper feeding. In addition, the other motor 26b is used for controlling the horizontal movement of the medium 34. After reading the print data 30, the controller 22 knows the total number and locations of pixels which are needed to be printed, and then determines the size of the swath area on the medium 34. In other words, the controller 22 outputs the controlling signal to the printhead 28 to drive the printhead 28 to print the print data 30 on the medium 34 according to the print data 30 after the controller 22 reads the print data 30.

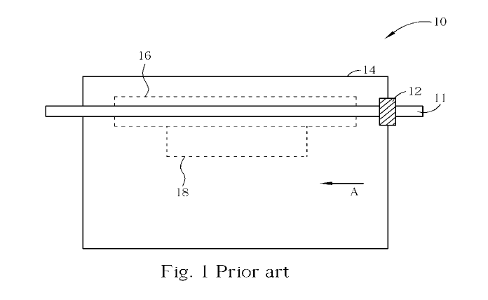

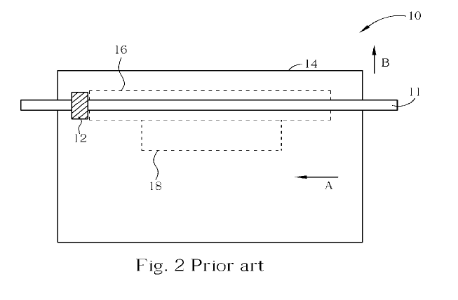

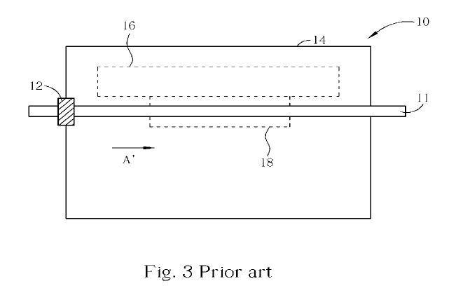

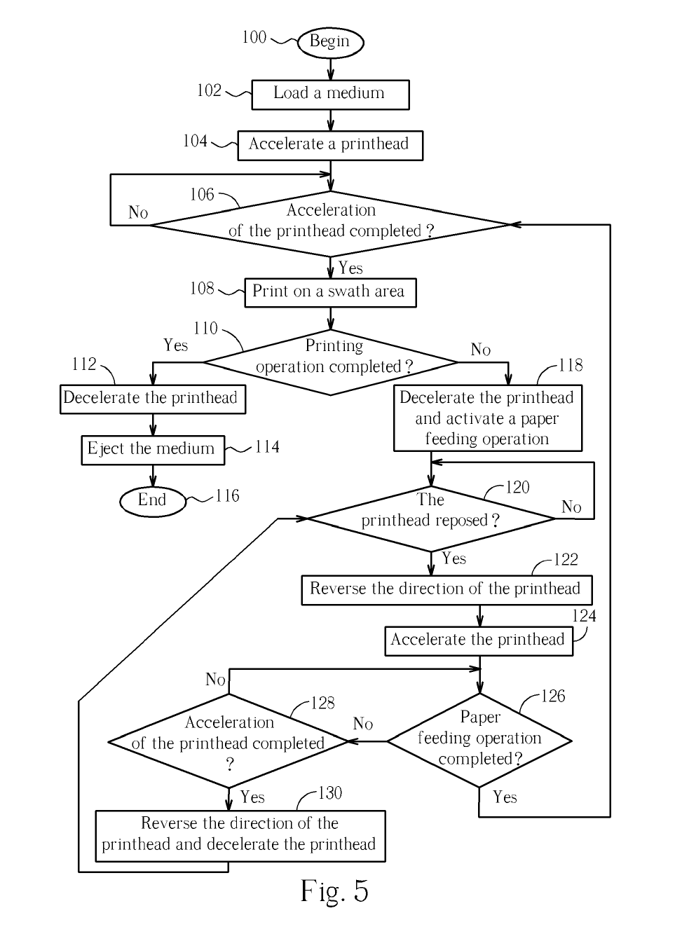

Please refer to FIG. 5. FIG. 5 is the first operation flowchart of the printing device 20 in FIG. 4. The printing device 20 prints the print data 30 stored in the storage device 24a as described in the following steps. When a user activates the printing operation (step 100), the controller 22 of the printing device 20 drives the motor 26a to load the medium 34 so as to print the print data 30 on it (step 102). After the medium 34 is loaded into the printing device 20, the controller 22 drives the motor 26b to drive the printhead 28 to accelerate toward a first swath area on the medium 34 (such as the swath area 16 in FIG. 1) (step 104). Meanwhile, the controller 22 determines whether the printhead 28 has arrived at the first swath area and completed the acceleration (step 106). If the printhead 28 has not arrived at the swath area, the controller 22 will continue to detect whether the printhead 28 has completed the acceleration or not; otherwise the controller 22 will drive the printhead 28 with a steady speed according to the print data 30 in order to print the print data 30 on the first swath area (step 108). That is to say, when the printhead 28 arrives at the first swath area and is accelerated from a first speed to a second speed, the controller 22 will drive the motor 26b in order to drive the printhead 28 to move with the second speed steadily.

When the printhead 28 leaves the first swath area, the controller 22 determines whether the printing operation has been finished or not (step 110). If all the contents of the print data 30 are printed on the medium 34, the controller 22 will drive the motor 26b in order to decelerate the printhead 28 until it stops (step 112) In other words, the controller 22 controls the motor 26b to drive the printhead 28 to decelerate from the first speed to a second speed, assuming that the printhead 28 moves with a first speed steadily in order to print on the medium 34. Then, the controller 22 drives the motor 26a to eject the medium 34 when the printhead 28 leaves the first swath area and is reposed (step 114) so that the user can take out the medium 34 with the print data 30 printed on, and finally finish the printing operation (step 116).

On the other hand, if not all the contents of the print data 30 are printed on the medium 34, the printhead 28 may continue printing on the second swath area (such as swath area 18 in FIG. 1) next to the first swath area. So, when the printhead 28 leaves the first swath area, the controller 22 drives the motor 26b to decelerate the printhead 28 until it stops. Meanwhile the controller 22 also drives the motor 26a to activate a paper feeding operation so as to move the second swath area into the processing area of the printhead 28 (step 118). Then the controller 22 will detect whether the printhead is reposed or not (step 120). The controller 22 will continue detecting the movement of the printhead 28 if the printhead 28 is not yet reposed, and the controller 22 will reverse the direction of the printhead 28 if the printhead 28 is reposed (step 122). For example, if the controller 22 originally controls the horizontal movement of the printhead 28 from left to right, the controller 22 will control the printhead to move from right to left after step 122 in order to continue the printing operation.

Afterwards, the controller 22 drives the printhead 28 to accelerate the second swath area after the printhead 28 is reposed (step 124). Meanwhile, the controller 22 determines whether the paper feeding operation corresponding to the second printing area has finished (step 126). If the second printing area has been moved into the processing area of the printhead 28 and the medium 34 is reposed, the controller 22 will progress to step 106 to determine whether the printhead 28 has arrived at the second swath area and completed the acceleration or not.

However, if the second swath area has not yet moved into the processing area of the printhead 28, which means that the motor 26a is still driving the medium 34 to move, the controller 22 will detect whether the printhead 28 has arrived at the second swath area and completed the acceleration (step 128). If the printhead 28 has not yet arrived at the second swath area, the controller 22 will determine whether the paper feeding operation has finished or not. If the printhead 28 has arrived at the second swath area and the acceleration has finished but the paper feeding corresponding to the second swath area has not yet finished (i.e. the first swath area has not totally left the processing area of the printhead 28), the controller 22 will not continue driving the printhead to print the print data 30. Meanwhile the controller 22 will reverse the direction of movement of the printhead 28 so as to have the printhead 28 leave the second swath area that is moving, and control the motor 26d to decelerate the printhead 28 until it stops (step 130).

Step 130 is to drive the printhead 28 to re-operate the acceleration toward the second swath area. So after step 130, the controller 22 will determine whether the printhead 28 is reposed or not and complete the deceleration (step 120). When the printhead 28 is reposed, step 122 and 124 will be operated again. The controller 22 will drive the printhead 28 to accelerate toward the second swath area if the printhead 28 has finished the acceleration and the paper feeding operation has not yet been finished. When the paper feeding operation corresponding to the second swath area has been finished, the controller 22 will not repeatedly accelerate the printhead 28 after step 126. Then the controller 22 will continue driving the printhead 28 to print on the second swath area according to the print data 30.

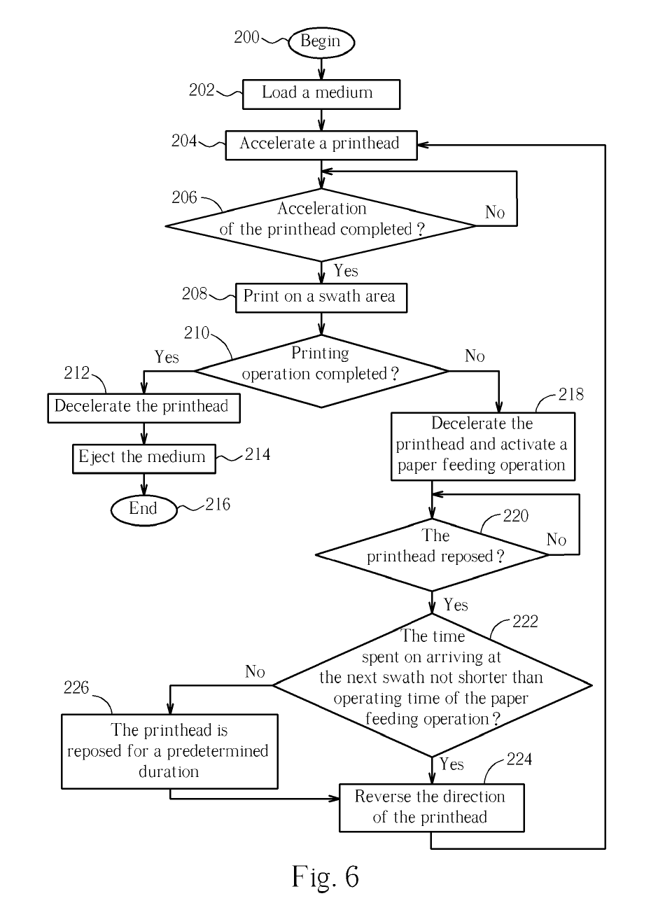

Please refer to FIG. 6. FIG. 6 is the second operation flowchart of the printing device 20 in FIG. 4. The printing device 20 prints the print data 30 stored in the storage device 24a as described in the follow steps. When a user activates the printing operation (step 200), the controller 22 of the printing device 20 drives the motor 26a to load a medium 34 to print the print data 30 on (step 202). When the medium 34 has been loaded to the printing device 29, the controller 22 begins to drive the motor 26b to drive the printhead 28 to accelerate the medium 34 toward a first printing area (such as the swath area 16 in FIG. 1) (step 204). Meanwhile the controller 22 determines whether the printhead 28 has arrived at the first swath area or not and completed the acceleration (step 206). If the printhead 28 has not yet arrived at the swath area, the controller 22 will continue detecting whether the printhead 28 has finished the acceleration or not. Otherwise the controller 22 will drive the printhead 28 to print with a steady speed on the first swath area according to the print data 30 (step 208).

When the printhead 28 leaves the first swath area, the controller 22 will determine whether the printing operation of the print data 30 has been finished or not. If all the contents of the print data 30 are printed on the medium 34, the controller 22 will drive the motor 26b to decelerate the printhead 28 until it stops (step 212). When the printhead 28 leaves the first swath area and is reposed, the controller 22 will drive the motor 26a to eject the medium 34 (step 214), so that the user can take out the medium 34 with the print data 30 printed on and finish the printing operation (step 216). On the other hand, if not all the contents of the print data 30 are printed on the medium 34 so that the printhead 28 has to continue to print on the second swath area next to the first swath area (such as the swath area 18 in FIG. 1.), the controller 22 will drive the motor 26b to decelerate the printhead until it stops when the printhead 28 leaves the first swath area. Meanwhile the controller 22 will also drive the motor 26a to activate the paper feeding operation in order to move the second swath area to the processing area of the printhead 28 (step 218).

The controller 22 will detect whether the printhead 28 is reposed (step 220). If the printhead 28 is not reposed, the controller 22 will continue to detect the movement of the printhead 28; on the other hand, when the printhead is reposed, the controller 22 will count the time that the printhead 28 needs to arrive at the second swath area by prior art deceleration and acceleration, and the time that the second swath area totally spends on arriving in the processing area of the printhead 28. This allows the present invention to determine whether the printhead 28 should be reposed for a predetermined duration in order to adjust the time printhead 28 spends on arriving in the second swath area (step 222).

The motors 26a and 26b of the present invention are both stepping motors, so the time to drive the printhead 28 and the medium 34 to move a certain distance can be counted according to the stepping angle of the motors. If the time that the printhead 28 needs to arrive at the second swath area is longer than or equal to the time that the medium 34 needs to complete the paper feeding operation corresponding to the second swath area, then it means that the paper feeding operation corresponding to the second swath area will be finished before the printhead 28 arrives at the second swath area, which means that the controller 22 does not have to delay the timing of the acceleration of the printhead 28. As a result, the controller 2 will reverse the direction of the printhead 28 when the printhead 28 is reposed (step 224), and then operate step 204 to activate the acceleration of the printhead 28 according to the adjusted direction.

For example, if the controller 22 originally controls the printhead 28 to decelerate until it stops the horizontal movement from left to right, the controller 22 will then control the printhead 28 to accelerate from right to left to continue the printing operation after step 224 and 204. On the other hand, if the time that the printhead 28 needs to arrive at the second swath area is shorter than the time the medium 34 needs to complete the paper feeding operation corresponding to the second swath area, then it means that the paper feeding operation corresponding to the second swath area will be finished after the printhead 28 arrives at the second swath area. Consequently, the controller 22 will have to delay the timing of activating the acceleration of the printhead 28 so as to control the paper feeding operation of the second swath area to be finished before the printhead 28 arrives at the second swath area. In turn, the controller 22 will keep the printhead 28 in a reposed state for a predetermined duration in order to increase the time it takes the printhead 28 to arrive at the second swath area (step 226). When the printhead 28 has been held for a predetermined duration, the controller 22 will reverse the direction of the printhead 28, and operate step 204 to activate the acceleration of the printhead 28 according to the adjusted direction.

In contrast to the prior art, the present invention provides a method for boosting the speed of a printer by driving the originally reposed printhead to move toward the moving swath area, which means that the paper feeding operation will be finished in the duration of the deceleration after the printhead has finished the present printing operation on the current swath area and the acceleration before the printhead operate the printing operation on the next swath area. This allows the duration between the time that the printhead leaves the swath area done and the time that the printhead arrives at the next swath area to be shortened. Furthermore, the present invention also provides a protection mechanism to avoid the printhead from beginning the printing operation before the paper feeding operation has been finished. If the printhead has entered the swath area and finds out that the paper feeding operation has not been finished, the printhead will stop, turn around, decelerate until it stops, and accelerate toward the swath area to be printed. In this way, the present invention ensures the printing quality with the protection mechanism.

The present invention also calculates the time of the paper feeding operation and the printhead movement in advance in order to determine the timing of the acceleration of the printhead toward the swath area needed to be printed so that the paper feeding operation can be finished before the printhead arrives at the swath area needed to be printed by adjusting the time of the printhead movement. Since the paper feeding operation will be finished in the duration of the deceleration after the printhead finishes the printing operation on the current swath area and the acceleration before the next printing operation of the next swath area needed to be printed, the operation time between the time that the printhead leaves the current swath area and the time that the printhead arrives at the next swath area is greatly shortened, and the printing speed can be boosted.

Those skilled in the art will readily observe that numerous modifications and alterations of the device and method may be made while retaining the teachings of the invention. Accordingly, the above disclosure should be construed as limited only by the metes and bounds of the appended claims.

1. A method for driving a printing device to print a first print data and a second print data on a medium, the printing device having a printhead, the medium having a first swath area and a second swath area, the method comprising:
(a) moving the printhead along a first direction toward the first swath area, and controlling the printhead to print the first print data on the first swath area; and
(b) when the printhead has printed the first print data on the first swath area, moving the printhead to approach the second swath area along a second direction opposite of the first direction while the medium moves along a predetermined direction.

2. The method of claim 1 wherein there is a certain angle between the predetermined direction and the first direction.

3. The method of claim 1 further comprising:
(c) when the printhead leaves the first swath area and moves along the first direction, moving the second swath area along the predetermined direction.

4. The method of claim 3 wherein in step (c), the printhead is decelerated from a first speed to a second speed.

5. The method of claim 1 wherein in step (a), the printhead moves according to a steady speed to print the first print data.

6. The method of claim 1 wherein in step (b), the printhead is accelerated from a first speed to a second speed.

7. The method of claim 1 wherein step (b) further comprises:
controlling the printhead to stay outside the second swath area while the medium is moving; and
controlling the printhead to enter into the second swath area while the medium becomes still.

8. The method of claim 1 wherein the size of the first swath area is determined by number of pixels in the first print data.

9. A method for driving a printing device, the printing device having a printhead, the method comprising:
(a) controlling the printhead to move along a first direction toward a first swath area of a medium, and controlling the printhead to print a print data on the first swath area according to the print data;
(b) when the printhead has left the first swath area according to the first direction, driving the medium to move along a predetermined direction, computing a first duration by counting the time it takes the medium to move according to the predetermined direction so that the printhead can print on a second swath area next to the first print swath area, and computing a second duration by counting the time it takes the printhead to move from the first print swath area to the second swath area along the second direction opposite to the first direction; and
(c) comparing the first duration with the second duration for controlling the timing when the printhead starts moving toward the second swath area according to the second direction.

10. The method of claim 9 wherein step (c) further comprises:
if the first duration is longer than the second duration, driving the printhead to stop during a predetermined duration and then accelerate to a first speed along the second direction, wherein sum of duration of the predetermined duration and the second duration is not shorter than the first duration.

11. The method of claim 9 wherein there is a certain angle between the predetermined direction and the first direction.

12. The method of claim 9 wherein in step (b), the printhead leaves the first swath area according to a first speed and then the printhead is decelerated to a second speed.

13. The method of claim 9 wherein in step (a), the printhead has a steady speed.

14. The method of claim 9 wherein the printing device further comprises a first motor for driving the printhead and a second motor for driving the medium, and step (c) computes the first and second durations according to the driving ability of the first and second motors.

15. The method of claim 14 wherein the first and second motors are stepping motors.

16. The method of clam 9 wherein the medium moves along the predetermined direction when the printhead moves along the second direction.

17. A printing device comprising:
a printhead for printing a first print data and a second print data on a first swath area and a second swath area respectively; and
a controller electrically connected to the printhead for controlling the printhead to move along a first direction to print the first print data on the first swath area, and controlling the medium to move along a predetermined direction and controlling the printhead to approach the second swath area along a second direction opposite to the first direction when the printhead has printed the first print data on the first swath area.

18. A printing device comprising:
a printhead for printing a print data on a first swath area of a medium along a first direction according to the print data; and
a controller electrically connected to the printhead, wherein when the printhead has left the first swath area according to the first direction, the controller controls the medium to move along a predetermined direction, computes a first duration by counting the time it takes the medium to move according to the predetermined direction so that the printhead can print on a second swath area next to the first print swath area, computes a second duration by counting the time it takes the printhead to move from the first print swath area to the second swath area along the second direction opposite to the first direction, and compares the first duration with the second duration for controlling the timing when the printhead starts moving toward the second swath area according to the second direction.
